(19) United States
(12) Patent Application Publication
(10) Pub. No.: US 2022/0203976 A1
(43) Pub. Date: Jun. 30, 2022

(54) TRAVEL CONTROL DEVICE FOR VEHICLE

(71) Applicant: ADVICS CO., LTD., Kariya-shi, Aichi-ken (JP)

(72) Inventor: Yosuke OMORI, Kariya-shi, Aichi-ken (JP)

(73) Assignee: ADVICS CO., LTD., Kariya-shi, Aichi-ken (JP)

(21) Appl. No.: 17/602,441

(22) PCT Filed: Apr. 7, 2020
(86) PCT No.: PCT/JP2020/015678

§ 371 Date: Oct. 8, 2021

(30) Foreign Application Priority Data
Apr. 25, 2019 (JP) 2019-084286

(51) Int. Cl. B60W 30/10

(52) U.S. Cl. CPC B60W 30/10; B60W 2552/00; B60W 2540/22; B60W 2710/20; B60W 2710/18

(57) ABSTRACT

A travel control device is a device that eliminates deviation of a vehicle from a target path by driving actuators when the vehicle deviates from the target path. The travel control device includes a movable range deriving unit that derives a movable range that is a range in which the vehicle is able to reach by driving the actuators on a basis of a traveling state of the vehicle, a target setting unit that sets a point included in the movable range in the target path as a target position, and an instruction unit that instructs the actuators to drive the vehicle toward the target position.

### TECHNICAL FIELD

The present disclosure relates to a travel control device for a vehicle.

### BACKGROUND ART

Patent Literature 1 describes an example of a travel control device that causes a vehicle to travel following a set target trajectory. When disturbance is input to a vehicle traveling following a target trajectory, the vehicle may deviate from the target trajectory. Examples of “input of disturbance” as used herein include a case where a vehicle receives a crosswind and a case where wheels pass a rut on a road surface.

In a case where the vehicle deviates from the target trajectory, the device described in Patent Literature 1 sets a point closest to the current position of the vehicle as a target position among a plurality of points on the target trajectory ahead of the current position. The travel of the vehicle is then controlled so that the vehicle is directed to the target position.

### CITATIONS LIST

### Patent Literature

Patent Literature 1: JP No. 2018-131042 A

### SUMMARY

### Technical Problems

As described above, in a case where the point closest to the current position of a vehicle among a plurality of points on a target trajectory is set as a target position, if the current position of the vehicle is too close to the target position, the vehicle may be required to travel beyond the movable range of the vehicle.

### Solutions to Problems

A travel control device for a vehicle to solve the above problem is a device that eliminates deviation of a vehicle from a target path by driving an actuator of the vehicle when the vehicle deviates from the target path. The travel control device for a vehicle includes a movable range deriving unit that derives a movable range that is a range in which the vehicle is able to reach by driving the actuator on a basis of a traveling state of the vehicle, a target setting unit that sets a point included in the movable range in the target path as a target position, and an instruction unit that instructs the actuator to drive the vehicle toward the target position.

With the above configuration, in the target path, a point that the vehicle is able to reach by driving the actuator is set as the target position. That is, it is possible to prevent a point that the vehicle cannot reach even if the actuator is driven to the maximum from being set as the target position. Therefore, it is possible to prevent the vehicle from being requested to travel beyond the movable range of the vehicle.

### BRIEF DESCRIPTION OF DRAWINGS

FIG. 1 is a block diagram illustrating a schematic configuration of a vehicle including a travel control device according to a first embodiment.

FIG. 2A and FIG. 2B are schematic diagrams illustrating an example of a movable range of a vehicle.

FIG. 3 is a schematic diagram illustrating an example of the movable range of the vehicle.

FIG. 4 is a flowchart for explaining a process routine performed at the time of deriving a movable range.

FIG. 5 is a schematic diagram illustrating a state where a target position is set on the basis of a target path and a movable range.

FIG. 6 is a block diagram illustrating a travel control device according to a second embodiment.

FIG. 7 is a schematic diagram illustrating an example of a movable range of a vehicle in a modification.

### DESCRIPTION OF EMBODIMENTS

### First Embodiment

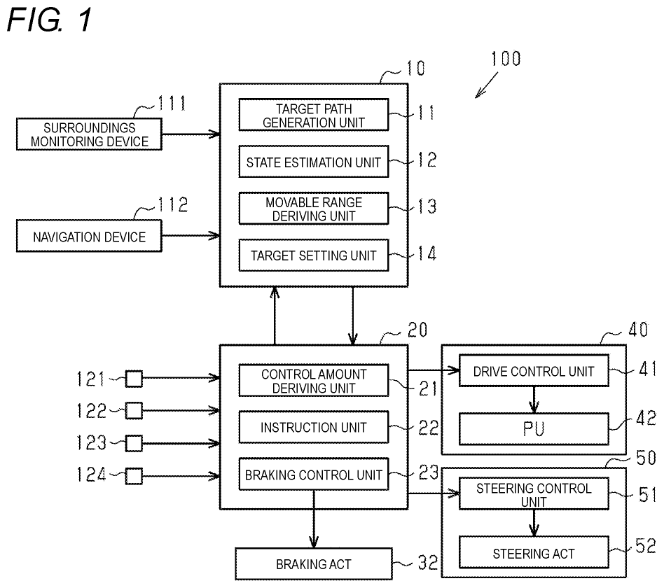

Hereinafter, a first embodiment of a travel control device for a vehicle will be described with reference to FIGS. 1 to 5.

As illustrated in FIG. 1, information is input to a travel control device 100 from a surroundings monitoring device 111 and a navigation device 112. Detection signals from various sensors 121, 122, 123, and 124 that detect the momentum of a vehicle are input to the travel control device 100.

The surroundings monitoring device 111 includes, for example, an image capturing device such as a camera and a radar. The surroundings monitoring device 111 acquires obstacle information that is information related to the size and position of an obstacle present around the vehicle. The obstacle herein refers to an obstacle with a size that requires avoidance of contact with the vehicle. Examples of such obstacle include other vehicles, pedestrians, guardrails, and walls. The surroundings monitoring device 111 then transmits the acquired obstacle information to the travel control device 100.

The navigation device 112 transmits map information that is information related to a map of an area where the vehicle travels and vehicle position information that is information for specifying the position of the vehicle on the map to the travel control device 100. The navigation device 112 herein may be an in-vehicle navigation device, a server installed outside the vehicle, or a mobile terminal owned by an occupant of the vehicle as long as the device can transmit the map information and the vehicle position information to the travel control device 100.

Examples of the various sensors include a yaw rate sensor 121, a longitudinal acceleration sensor 122, a lateral acceleration sensor 123, and a wheel speed sensor 124. The yaw rate sensor 121 detects a yaw rate Yr of the vehicle as the momentum of the vehicle, and outputs a signal corresponding to the yaw rate Yr as a detection signal. The longitudinal acceleration sensor 122 detects a longitudinal acceleration Gx of the vehicle as the momentum of the vehicle, and outputs a signal corresponding to the longitudinal acceleration Gx as a detection signal. The lateral acceleration sensor 123 detects a lateral acceleration Gy of the vehicle as the momentum of the vehicle, and outputs a signal corresponding to the lateral acceleration Gy as a detection signal. The wheel speed sensor 124 is provided for each wheel of the vehicle. The wheel speed sensor 124 detects a wheel speed VW of the corresponding wheel as the momentum of the vehicle, and outputs a signal corresponding to the wheel speed VW as a detection signal. The travel control device 100 then derives a vehicle body speed VS of the vehicle on the basis of the wheel speed VW of each wheel.

The travel control device 100 of the present embodiment includes a driving plan generation ECU 10 as a first electronic control device and a driving control ECU 20 as a second electronic control device. “ECU” is an abbreviation of “Electronic Control Unit”. The ECUs 10 and 20 can transmit and receive various types of information to and from each other. Information is input to the driving plan generation ECU 10 from the surroundings monitoring device 111 and the navigation device 112. Detection signals from the various sensors 121 to 124 are input to the driving control ECU 20.

As will be described in detail later, the driving plan generation ECU 10 generates an index of a traveling path of the vehicle in a case where the vehicle is autonomously driven as a target path TTL on the basis of the input information, and transmits a point on the generated target path TTL as a target position PTr to the driving control ECU 20. The driving control ECU 20 drives various in-vehicle actuators 32, 42, and 52 on the basis of detection signals from the various sensors 121 to 124 and various types of information transmitted from the driving plan generation ECU 10. In the present embodiment, the driving control ECU 20 also has a function of controlling the braking actuator 32 among the various actuators 32, 42, and 52. Further, the driving control ECU 20 can communicate with a drive control unit 41 of a drive device 40 in the vehicle and a steering control unit 51 of a steering device 50 in the vehicle.

The drive device 40 includes the power unit 42 among the various actuators 32, 42, and 52. The power unit 42 includes a power source of a vehicle such as an engine or an electric motor. The power unit 42 is controlled by the drive control unit 41. That is, the driving control ECU 20 can drive the power unit 42, that is, can adjust the driving force of the vehicle by instructing the drive control unit 41 to drive the power unit 42.

The steering device 50 includes the steering actuator 52 among the various actuators 32, 42, and 52, and drive of the steering actuator 52 is controlled by the steering control unit 51. That is, the driving control ECU 20 can drive the steering actuator 52, that is, can adjust the steering angle of the wheels by instructing the steering control unit 51 to drive the steering actuator 52.

Next, a functional configuration of the driving plan generation ECU 10 will be described.

The driving plan generation ECU 10 includes, as functional units, a target path generation unit 11, a state estimation unit 12, a movable range deriving unit 13, and a target setting unit 14.

The target path generation unit 11 generates the target path TTL. In a case where the vehicle is caused to travel in a travel lane, the target path generation unit 11 generates, for example, a path in which the vehicle passes through the center of the travel lane in the width direction as the target path TTL. In a case where an obstacle is present in front of the vehicle, the target path generation unit 11 generates a path for bypassing the obstacle as the target path TTL.

The state estimation unit 12 receives information related to the motion state of the vehicle grasped by the driving control ECU 20 to estimate the traveling state of the vehicle and the state of a road surface on which the vehicle travels. Examples of the information related to the driving state of the vehicle include the momentum of the vehicle such as the yaw rate Yr, the lateral acceleration Gy, the longitudinal acceleration Gx, and the vehicle body speed VS of the vehicle. These momenta indicate the traveling state of the vehicle as a result of the drive of the various actuators 32, 42, and 52. The state estimation unit 12 estimates, as the traveling state of the vehicle, for example, whether or not the vehicle is traveling straight, whether the vehicle is turning left or right in a case where the vehicle is turning, and whether or not there is a wheel in which a slip of a predetermined degree or more has occurred. In addition, the state estimation unit 12 estimates, for example, the p value and gradient of a road surface as the state of the road surface.

Furthermore, the state estimation unit 12 acquires the drive state of the various actuators 32, 42, and 52 on the basis of the information received from the driving control ECU 20. The state estimation unit 12 acquires a drive amount DBP of the braking actuator 32, a drive amount DPU of the power unit 42, and a drive amount DST of the steering actuator 52 as the drive state.

The movable range deriving unit 13 derives a movable range RT that is a range that the vehicle is able to reach by driving the various actuators 32, 42, and 52. That is, the movable range deriving unit 13 derives the movable range RT on the basis of the traveling state of the vehicle and the state of the road surface estimated by the state estimation unit 12, the drive state of the various actuators 32, 42, and 52 acquired by the state estimation unit 12, and an index Z related to the ride comfort felt by an occupant of the vehicle. A process of deriving the movable range RT will be described later.

When the momentum of the vehicle such as the lateral acceleration Gy of the vehicle increases or jerk that is also the rate of change of the momentum increases, the occupant of the vehicle tends to feel uncomfortable. Consequently, the index Z corresponds to a numerical value of the discomfort felt by the occupant of the vehicle in executing travel control to cause the vehicle to follow the target path TTL. In the present embodiment, the index Z is set in advance.

The target setting unit 14 determines whether or not the vehicle deviates from the target path TTL generated by the target path generation unit 11. For example, the target setting unit 14 derives the amount of deviation of the vehicle from the target path TTL on the basis of the vehicle position information. In this case, the shortest distance between the target path TTL and the current position of the vehicle can be derived as the amount of deviation of the vehicle from the target path TTL. The target setting unit 14 does not determine that the vehicle deviates from the target path TTL when the derived amount of deviation is less than an amount of deviation for determination, and determines that the vehicle deviates from the target path TTL when the amount of deviation is larger than or equal to the amount of deviation for determination.

When the target setting unit 14 does not determine that the vehicle deviates from the target path TTL, the target setting unit 14 sets, as the target position PTr, a point closest to the vehicle among a plurality of points on the target path TTL ahead of the current position of the vehicle.

On the other hand, when the target setting unit 14 determines that the vehicle deviates from the target path TTL, the target setting unit 14 sets, as the target position PTr, a point included in the movable range RT derived by the movable range deriving unit 13 among a plurality of points on the target path TTL ahead of the current position of the vehicle.

Note that the target setting unit 14 also sets a target attitude angle θTgt that is a target of the attitude angle of the vehicle when the vehicle reaches the target position PTr. “Attitude angle θ” used herein is an angle formed by the longitudinal direction of the vehicle at the present moment and the longitudinal direction of the vehicle at the time when the vehicle reaches the target position PTr. A process of setting the target position PTr and the target attitude angle θTgt in a case where it is determined that the vehicle deviates from the target path TTL will be described later.

When the target setting unit 14 sets the target position PTr and the target attitude angle θTgt, the driving plan generation ECU 10 transmits the target position PTr and the target attitude angle θTgt to the driving control ECU 20.

Next, a functional configuration of the driving control ECU 20 will be described.

The driving control ECU 20 includes, as functional units, a control amount deriving unit 21, an instruction unit 22, and a braking control unit 23.

The control amount deriving unit 21 derives a route for causing the vehicle to travel to the target position PTr received from the driving plan generation ECU 10 as a target travel route TTR. A process of deriving the target travel route TTR will be described later. The control amount deriving unit 21 derives control amounts DBPc, DPUc, and DSTc of the various actuators 32, 42, and 52 for causing the vehicle to travel on the derived target travel route TTR. At this time, the control amount deriving unit 21 derives the control amounts DBPc, DPUc, and DSTc of the various actuators 32, 42, and 52 in view of the target attitude angle θTgt.

Note that the derived control amounts DBPc, DPUc, and DSTc of the various actuators 32, 42, and 52 are transmitted to the driving plan generation ECU 10. The state estimation unit 12 of the driving plan generation ECU 10 acquires the control amounts DBPc, DPUc, and DSTc as the drive amounts DBP, DPU, and DST of the actuators 32, 42, and 52.

The instruction unit 22 instructs the various actuators 32, 42, and 52 to drive the vehicle toward the target position PTr. That is, the instruction unit 22 instructs the braking control unit 23 to drive the braking actuator 32 with the control amount DBPc of the braking actuator 32 derived by the control amount deriving unit 21. Further, the instruction unit 22 instructs the drive control unit 41 to drive the power unit 42 with the control amount DPUc of the power unit 42 derived by the control amount deriving unit 21. The instruction unit 22 instructs the steering control unit 51 to drive the steering actuator 52 with the control amount DSTc of the steering actuator 52 derived by the control amount deriving unit 21.

The braking control unit 23 controls the braking actuator 32 on the basis of the control amount DBPc derived by the instruction unit 22. That is, instructing the braking control unit 23 to drive the braking actuator 32 with the control amount DBPc derived by the instruction unit 22 corresponds to instructing the braking actuator 32 to drive the vehicle toward the target position PTr.

Note that when the control amount DPUc of the power unit 42 is transmitted from the driving control ECU 20 to the drive control unit 41, the drive control unit 41 controls the power unit 42 on the basis of the received control amount DPUc. That is, instructing the drive control unit 41 to drive the power unit 42 with the control amount DPUc derived by the instruction unit 22 corresponds to instructing the power unit 42 to drive the vehicle toward the target position PTr.

Furthermore, when the control amount DSTc of the steering actuator 52 is transmitted from the driving control ECU 20 to the steering control unit 51, the steering control unit 51 controls the steering actuator 52 on the basis of the received control amount DSTc. That is, instructing the steering control unit 51 to drive the steering actuator 52 with the control amount DSTc derived by the instruction unit 22 corresponds to instructing the steering actuator 52 to drive the vehicle toward the target position PTr.

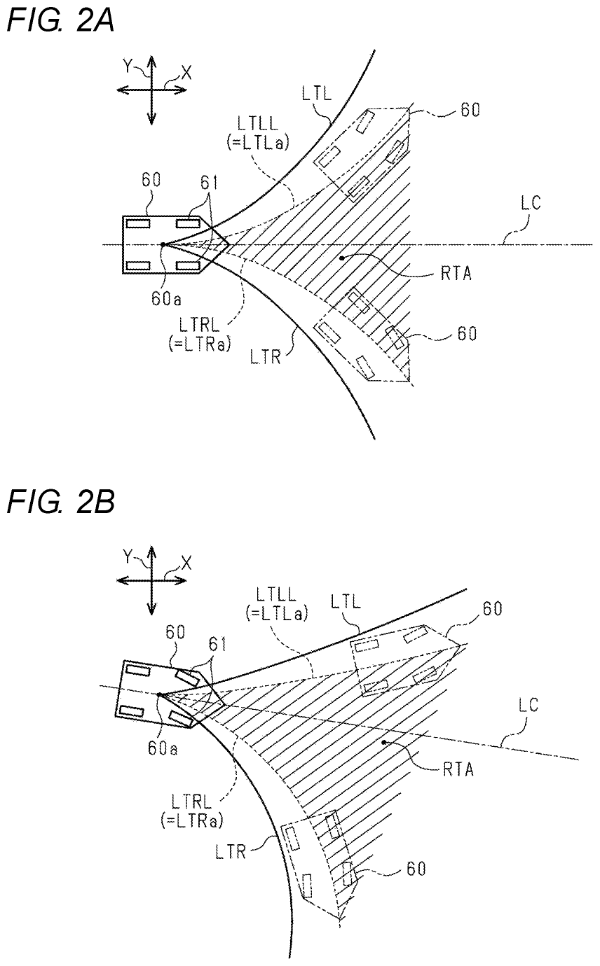

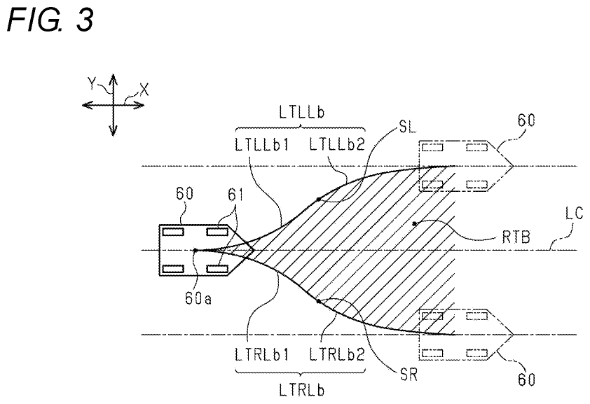

Next, a process of deriving the movable range RT performed by the movable range deriving unit 13 will be described. In FIGS. 2 and 3, “longitudinal direction X” is the longitudinal direction of a vehicle at the present moment, and “lateral direction Y” is the lateral direction of the vehicle at the present moment.

The movable range deriving unit 13 performs a process of deriving a unidirectional turning movable range RTA, which is a movable range in a case where the turning direction of the vehicle is not changed, and a process of deriving a bidirectional turning movable range RTB, which is a movable range in a case where the vehicle is turned to one of the right direction and the left direction of the vehicle and then the vehicle is turned to the other direction. In addition, the movable range deriving unit 13 performs a process of selecting one of the unidirectional turning movable range RTA and the bidirectional turning movable range RTB as the movable range RT.

First, a process of deriving the unidirectional turning movable range RTA will be described with reference to FIGS. 2A and 2B.

FIG. 2A illustrates an example of the unidirectional turning movable range RTA derived under a situation in which a vehicle 60 travels straight. A right turning limit line LTR indicated by a solid line in FIG. 2B shows a result of prediction of the turning path of the vehicle 60 in a case where the turning amount of the vehicle 60 in the right direction is maximized in a range in which the occurrence of sideslip of the vehicle 60 can be suppressed. Similarly, a left turning limit line LTL indicated by a solid line in FIG. 2A shows a result of prediction of the turning path of the vehicle 60 in a case where the turning amount of the vehicle 60 in the left direction is maximized in a range in which the occurrence of sideslip of the vehicle 60 can be suppressed. The right turning limit line LTR and the left turning limit line LTL are respectively derived on the basis of the weight of the vehicle 60, the μ value of a road surface on which the vehicle 60 travels, the cornering power of wheels 61 of the vehicle 60, and the sideslip angle of the wheels 61. The cornering power can be derived on the basis of the vehicle body speed VS, the lateral acceleration Gy, the yaw rate Yr, and the like of the vehicle 60.

A vehicle center line LC indicated by a one-dot chain line in FIG. 2A is a straight line extending in the longitudinal direction X and passing through a position of center of gravity 60a of the vehicle. In the lateral direction Y, the distance between the vehicle center line LC and the right turning limit line LTR and the distance between the vehicle center line LC and the left turning limit line LTL become larger as the vehicle 60 moves away from the current position in the longitudinal direction X, but the center between the right turning limit line LTR and the left turning limit line LTL is located on the vehicle center line LC. In addition, the smaller the p value of the road surface, the less likely the distance increases even if the vehicle 60 moves away from the current position in the longitudinal direction X. Further, the lower the weight of the vehicle 60, the less likely the distance increases even if the vehicle 60 moves away from the current position in the longitudinal direction X. Moreover, the smaller the cornering power, the less likely the distance increases even if the vehicle 60 moves away from the current position in the longitudinal direction X. Furthermore, the smaller the sideslip angle of the wheels 61, the less likely the distance increases even if the vehicle 60 moves away from the current position in the longitudinal direction X.

FIG. 2A illustrates a restricted right turning limit line LTRL and a restricted left turning limit line LTLL as a result of prediction of the turning path of the vehicle 60 in view of the index Z related to the ride comfort felt by an occupant of the vehicle. In a case where the turning path of the vehicle 60 is outside the region surrounded by the restricted right turning limit line LTRL and the restricted left turning limit line LTLL in the lateral direction Y, the occupant of the vehicle 60 may feel uncomfortable.

The movable range RT is derived on the basis of the right turning limit line LTR, the left turning limit line LTL, the restricted right turning limit line LTRL, and the restricted left turning limit line LTLL. That is, one of the right turning limit line LTR and the restricted right turning limit line LTRL that is closer to the vehicle center line LC in the lateral direction Y is selected as a right limit line LTRa. Similarly, one of the left turning limit line LTL and the restricted left turning limit line LTLL that is closer to the vehicle center line LC in the lateral direction Y is selected as a left limit line LTLa. The region between the right limit line LTRa and the left limit line LTLa is derived as the movable range RT. That is, in a case where the region surrounded by the right turning limit line LTR and the left turning limit line LTL is set as the maximum movable range and the region surrounded by the restricted right turning limit line LTRL and the restricted left turning limit line LTLL is set as the restricted movable range, a narrower one of the maximum movable range and the restricted movable range is selected as the movable range RT.

Note that FIG. 2A illustrates an example of a case where the right turning limit line LTR is located outside the restricted right turning limit line LTRL in the lateral direction Y, and the left turning limit line LTL is located outside the restricted left turning limit line LTLL in the lateral direction Y. As a result, the restricted right turning limit line LTRL is selected as the right limit line LTRa, and the restricted left turning limit line LTLL is selected as the left limit line LTLa. That is, the restricted movable range is selected as the movable range RT. However, depending on the traveling state of the vehicle and the state of the road surface, the right turning limit line LTR may be located inside the restricted right turning limit line LTRL in the lateral direction Y, and the left turning limit line LTL may be located inside the restricted left turning limit line LTLL in the lateral direction Y. In this case, the right turning limit line LTR is selected as the right limit line LTRa, and the left turning limit line LTL is selected as the left limit line LTLa. That is, the maximum movable range is selected as the movable range RT.

FIG. 2B illustrates an example of the unidirectional turning movable range RTA derived under a situation in which the vehicle 60 turns right by the steering of the wheels 61 due to drive of the steering actuator 52. In a case where the vehicle 60 has already turned right, it is easy to further increase the amount of turning of the vehicle 60 in the right direction, but it is difficult to turn the vehicle 60 to the left. Consequently, as illustrated in FIG. 2B, the distance between the vehicle center line LC and the right turning limit line LTR and the distance between the vehicle center line LC and the left turning limit line LTL become larger as the vehicle 60 moves away from the current position in the longitudinal direction X, but the center between the right turning limit line LTR and the left turning limit line LTL is located on the right side of the vehicle center line LC.

Under a situation in which the vehicle 60 turns to the left by the steering of the wheels 61 due to drive of the steering actuator 52, it is easy to further increase the turning amount of the vehicle 60 in the left direction, but it is difficult to turn the vehicle 60 to the right. Consequently, the distance between the vehicle center line LC and the right turning limit line LTR and the distance between the vehicle center line LC and the left turning limit line LTL become larger as the vehicle 60 moves away from the current position in the longitudinal direction X, but the center between the right turning limit line LTR and the left turning limit line LTL is located on the left side of the vehicle center line LC.

Note that the outward expansion in the lateral direction Y of the restricted right turning limit line LTRL and the restricted left turning limit line LTLL in view of the index Z is also similar to the outward expansion in the lateral direction Y of the right turning limit line LTR and the left turning limit line LTL as illustrated in FIG. 2(b).

Next, a process of deriving the bidirectional turning movable range RTB will be described with reference to FIG. 3. In FIG. 3, “longitudinal direction X” is the longitudinal direction of the vehicle 60 at the present moment, and “lateral direction Y” is the lateral direction of the vehicle 60 at the present moment.

A right limit line LTRLb illustrated in FIG. 3 is a line in a case where the vehicle 60 is turned right and then left. The first half portion of the right limit line LTRLb corresponds to a first half right limit line LTRLb1 derived by the same method as that of the right limit line LTRa described with reference to FIG. 2. The second half portion of the right limit line LTRLb corresponds to a second half right limit line LTRLb2 derived by the same method as that of the left limit line LTLa described with reference to FIG. 2 under the assumption that the vehicle 60 is positioned at an end point SR of the first half right limit line LTRLb1.

On the other hand, a left limit line LTLLb illustrated in FIG. 3 is a line in a case where the vehicle 60 is turned left and then left. The first half portion of the left limit line LTLLb corresponds to a first half left limit line LTRLb1 derived by the same method as that of the left limit line LTLa described with reference to FIG. 2. The second half portion of the left limit line LTLLb corresponds to a second half left limit line LTLLb2 derived by the same method as that of the right limit line LTRa described with reference to FIG. 2 under the assumption that the vehicle 60 is positioned at an end point SL of the first half left limit line LTLLb1.

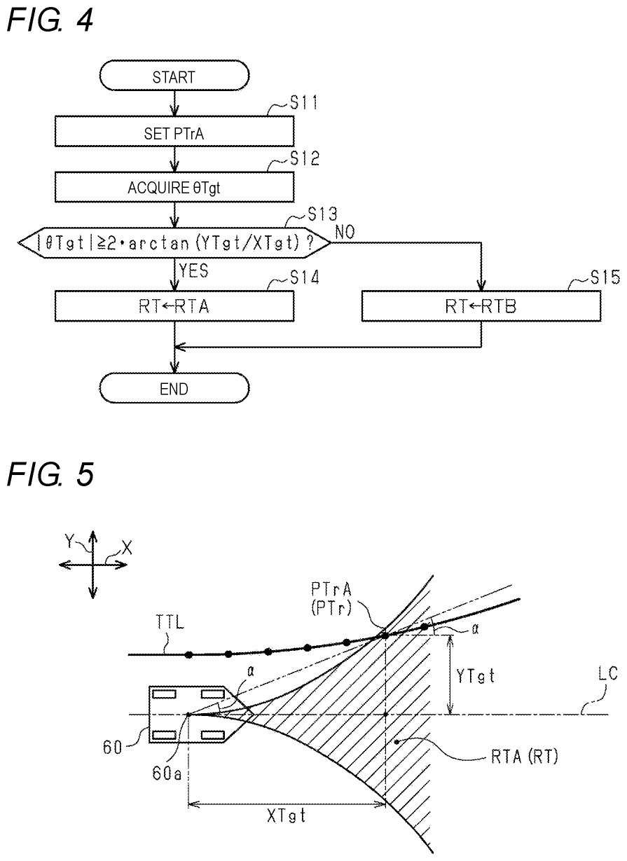

Next, a process of selecting one of the unidirectional turning movable range RTA and the bidirectional turning movable range RTB as the movable range RT will be described with reference to FIGS. 4 and 5. This process routine is performed when the derivation of the unidirectional turning movable range RTA and the bidirectional turning movable range RTB is completed.

In this process routine, in step S11, a point included in the unidirectional turning movable range RTA in the target path TTL ahead of the vehicle 60 is set as a temporary target position PTrA. That is, as illustrated in FIG. 5, among a plurality of points on the target path TTL included in the unidirectional turning movable range RTA, a point closest to the vehicle 60 in the longitudinal direction X is set as the temporary target position PTrA.

Returning to FIG. 4, in the next step S12, the target attitude angle θTgt is set. For example, the attitude angle θ according to the traveling lane of the vehicle 60 is set as the target attitude angle θTgt. In this case, when the traveling lane of the vehicle 60 is a curved road, the attitude angle θ according to the radius of curvature of the curved road is set as the target attitude angle θTgt. That is, a value different from “0 (zero)” is set as the target attitude angle θTgt. On the other hand, in a case where the traveling lane of the vehicle 60 is a straight road, “0 (zero)” or a value close to “0 (zero)” is set as the target attitude angle θTgt.

Subsequently, in step S13, it is determined whether or not the attitude angle θ at the temporary target position PTrA can be set as the target attitude angle θTgt when the vehicle 60 is caused to travel to the temporary target position PTrA without changing the turning direction of the vehicle 60.

In the present embodiment, the determination is made using the following relational expressions (Formula 1) and (Formula 2). In the relational expression (Formula 1), “YTgt” indicates the amount of lateral shift that is the amount of shift in the lateral direction Y between the current position of the vehicle 60 and the temporary target position PTrA. “XTgt” indicates the amount of longitudinal shift that is the amount of shift in the longitudinal direction X between the current position of the vehicle 60 and the temporary target position PTrA.

α=arctan(YTgt/XTgt) (Formula 1)

|θTgt|≥2α (Formula 2)

In a case where the product of the calculated angle α, which is the angle calculated using the relational expression (Formula 1), and “2” is equal to or less than the absolute value of the target attitude angle θTgt, it is determined that the attitude angle θ at the temporary target position PTrA can be set as the target attitude angle θTgt when the vehicle 60 is caused to travel to the temporary target position PTrA without changing the turning direction of the vehicle 60. On the other hand, in a case where the product of the calculated angle α and “2” is larger than the absolute value of the target attitude angle θTgt, it is not determined that the attitude angle θ at the temporary target position PTrA can be set as the target attitude angle θTg. Consequently, in a case where the product of the calculated angle α and “2” is equal to or less than the absolute value of the target attitude angle θTgt (step S13: YES), the process proceeds to the next step S14. In step S14, the unidirectional turning movable range RTA is selected as the movable range RT. Then, this process routine is ended. On the other hand, in a case where the product of the calculated angle α and “2” is larger than the absolute value of the target attitude angle θTgt (step S13: NO), the process proceeds to the next step S15. In step S15, the bidirectional turning movable range RTB is selected as the movable range RT. Then, this process routine is ended. That is, in the present embodiment, one of the unidirectional turning movable range RTA and the bidirectional turning movable range RTB is selected as the movable range RT on the basis of the current position of the vehicle, the temporary target position PTrA, and the target attitude angle θTgt.

Next, a process performed by the target setting unit 14 when the target setting unit 14 sets the target position PTr on the basis of the movable range RT will be described with reference to FIG. 5.

As illustrated in FIG. 5, a point included in the movable range RT in the target path TTL ahead of the vehicle 60 is set as the target position PTr. In the present embodiment, among a plurality of points on the target path TTL included in the movable range RT, a point closest to the vehicle 60 in the longitudinal direction X is set as the target position PTr. Then, the process of setting the target position PTr is ended.

Note that FIG. 5 illustrates an example of a case where the unidirectional turning movable range RTA is selected as the movable range RT. The setting of the target position PTr in a case where the bidirectional turning movable range RTB is selected as the movable range RT is similar to that in a case where the unidirectional turning movable range RTA is selected as the movable range RT.

Then, when the target position PTr is set, the driving plan generation ECU 10 transmits the target position PTr and the target attitude angle θTgt to the driving control ECU 20. At this time, information as to whether the unidirectional turning movable range RTA or the bidirectional turning movable range RTB is selected as the movable range RT is also transmitted to the driving control ECU 20.

Next, a process performed by the control amount deriving unit 21 when the control amount deriving unit 21 derives the target travel route TTR will be described.

When the driving control ECU 20 receives the target position PTr and the target attitude angle θTgt from the driving plan generation ECU 10, the control amount deriving unit 21 derives the target travel route TTR. At this time, a route in which the attitude angle θ when the vehicle 60 reaches the target position PTr is equal to the target attitude angle θTgt is derived as the target travel route TTR. Specifically, the target travel route TTR is derived on the basis of whether the movable range RT selected at the time of setting the target position PTr is the unidirectional turning movable range RTA or the bidirectional turning movable range RTB. When the unidirectional turning movable range RTA is selected, a route in which the turning direction of the vehicle 60 is not changed until the vehicle 60 reaches the target position PTr is derived as the target travel route TTR. On the other hand, when the bidirectional turning movable range RTB is selected, a route in which the turning direction of the vehicle 60 is switched before the vehicle 60 reaches the target position PTr is derived as the target travel route TTR. When the target travel route TTR is derived in this manner, the process of deriving the target travel route TTR is ended.

Operations and effects of the present embodiment will be described.

(1) In the target path TTL, a point that the vehicle 60 is able to reach by driving the actuators 32, 42, and 52 is set as the target position PTr. That is, a point where the vehicle 60 cannot reach even if the actuators 32, 42, and 52 are driven to the maximum is not set as the target position PTr. Consequently, in eliminating the deviation of the vehicle 60 from the target path TTL, it is possible to prevent the vehicle 60 from being requested to travel beyond the movable range of the vehicle 60.

(2) In the present embodiment, the movable range RT is derived in view of the traveling state of the vehicle 60. For example, in a case where the vehicle 60 turns right, the movable range RT that extends largely to the right side of the vehicle 60 but does not extend so much to the left side of the vehicle 60 is derived. In the target path TTL, a point included in such a movable range RT is set as the target position PTr. That is, it is possible to enhance an effect of preventing a point in the target path TTL that the vehicle 60 cannot reach even by driving the actuators 32, 42, and 52 from being set as the target position PTr.

(3) In the present embodiment, the movable range RT is also derived in view of the state of the road surface on which the vehicle 60 travels. For example, the movable range RT that does not extend so much to the left and right of the vehicle 60 as the p value of the road surface is smaller is derived. In the target path TTL, a point included in such a movable range RT is set as the target position PTr. That is, it is possible to enhance an effect of preventing a point in the target path TTL that the vehicle 60 cannot reach even by driving the actuators 32, 42, and 52 from being set as the target position PTr.

(4) In the present embodiment, the movable range RT is derived in view of the index Z. The index Z is a numerical value of the ride comfort felt by the occupant of the vehicle. In the target path TTL, a point included in such a movable range RT is set as the target position PTr, and the travel of the vehicle 60 toward the target position PTr is controlled. Consequently, when the vehicle 60 is caused to travel toward the target position PTr, it is possible to suppress a sudden change in the momentum of the vehicle. As a result, it is possible to suppress discomfort felt by the occupant of the vehicle 60 when the vehicle 60 is caused to travel toward the target position PTr.

(5) In the present embodiment, the unidirectional turning movable range RTA and the bidirectional turning movable range RTB are derived. In view of the target attitude angle θTgt, one of the unidirectional turning movable range RTA and the bidirectional turning movable range RTB is then selected as the movable range RT, and in the target path TTL, a point included in such a movable range RT is set as the target position PTr. The target travel route TTR toward the target position PTr is then derived. At this time, the target travel route TTR is derived in view of whether the unidirectional turning movable range RTA or the bidirectional turning movable range RTB is selected as the movable range RT. The vehicle 60 then travels along the target travel route TTR. As a result, when the vehicle 60 reaches the target position PTr, the attitude angle θ can be made substantially equal to the target attitude angle θTgt. Consequently, after the vehicle 60 reaches the target position PTr, the vehicle 60 is less likely to deviate from the target path TTL.

### Second Embodiment

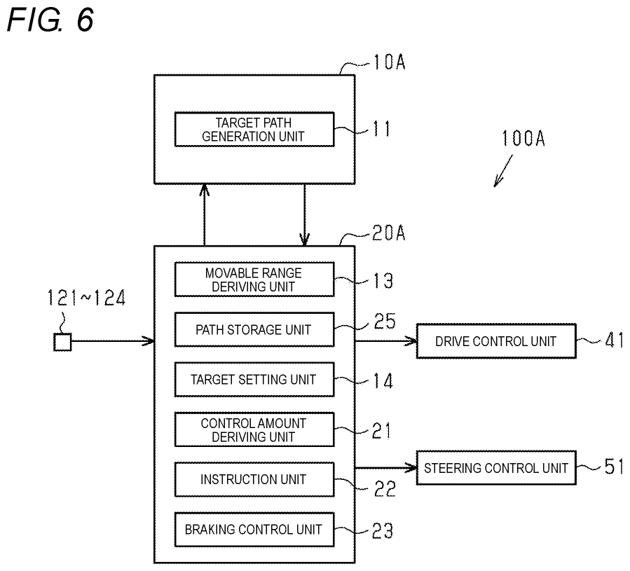

Next, a second embodiment of a travel control device for a vehicle will be described with reference to FIG. 6. The second embodiment is different from the first embodiment in that derivation of the movable range RT and setting of the target position PTr are performed by a driving control ECU. Therefore, portions different from those of the first embodiment will be mainly described in the following description, and the same reference numerals will be given to the same or corresponding constituent members as those of the first embodiment, and redundant description will be omitted.

As illustrated in FIG. 6, a travel control device 100A includes a driving plan generation ECU 10A as a first electronic control device and a driving control ECU 20A as a second electronic control device. The driving plan generation ECU 10A includes the target path generation unit 11 as a functional unit. The driving plan generation ECU 10A determines whether or not the vehicle 60 deviates from the target path TTL generated by the target path generation unit 11. Then, when it is determined that the vehicle 60 deviates from the target path TTL, the driving plan generation ECU 10A transmits the fact to the driving control ECU 20.

The driving control ECU 20A includes, as functional units, the movable range deriving unit 13, a path storage unit 25, the target setting unit 14, the control amount deriving unit 21, the instruction unit 22, and the braking control unit 23.

The movable range deriving unit 13 derives the movable range RT similarly to the case of the first embodiment. The driving control ECU 20A also has a function of controlling the braking actuator 32. Consequently, the driving control ECU 20A grasps the momentum of a vehicle such as the yaw rate Yr and the lateral acceleration Gy of the vehicle 60, the cornering power of the wheels 61, and the sideslip angle of the wheels 61, and also grasps information about the road surface on which the vehicle 60 travels. As a result, the movable range deriving unit 13 derives the movable range RT on the basis of the momentum of the vehicle and the information about the road surface grasped by the driving control ECU 20A, and the drive amounts DBP, DPU, and DST of the various actuators 32, 42, and 52.

The path storage unit 25 stores the target path TTL received by the driving control ECU 20A.

When the target setting unit 14 does not receive the determination that the vehicle 60 deviates from the target path TTL from the driving plan generation ECU 10A, the target setting unit 14 sets, as the target position PTr, a point closest to the vehicle 60 in the target path TTL ahead of the current position of the vehicle 60. On the other hand, when the target setting unit 14 receives the determination that the vehicle 60 deviates from the target path TTL from the driving plan generation ECU 10A, the target setting unit 14 sets, as the target position PTr, a point included in the movable range RT derived by the movable range deriving unit 13 in the target path TTL ahead of the current position of the vehicle 60. Note that the target path TTL used to set the target position PTr is the latest version of the target path TTL stored in the path storage unit 25.

The target setting unit 14 also sets the target attitude angle θTgt that is a target of the attitude angle of the vehicle 60 when the vehicle 60 reaches the target position PTr.

When the target position PTr is set by the target setting unit 14, the control amount deriving unit 21 derives a route for causing the vehicle 60 to travel to the target position PTr as the target travel route TTR. As in the first embodiment, the control amount deriving unit 21 derives the control amounts DBPc, DPUc, and DSTc of the various actuators 32, 42, and 52.

As in the first embodiment described above, the instruction unit 22 instructs the various actuators 32, 42, and 52 to drive the vehicle 60 toward the target position PTr.

As in the first embodiment described above, the braking control unit 23 controls the braking actuator 32 on the basis of the control amount DBPc derived by the instruction unit 22.

In the present embodiment, operations and effects equivalent to those of the first embodiment can be obtained.

(Modifications)

Each of the embodiments described above can be modified as follows. The embodiments described above and the following modifications can be implemented in combination with each other as long as they do not technically contradict with each other.

In the first embodiment, the movable range deriving unit 13 derives the movable range RT on the basis of the traveling state of the vehicle, the state of the road surface, the drive state of the various actuators 32, 42, and 52, and the index Z related to the ride comfort felt by the occupant of the vehicle. The traveling state of the vehicle, the state of the road surface, and the drive state of the various actuators 32, 42, and 52 are based on information received from the driving control ECU 20. As a result, the traveling state of the vehicle, the state of the road surface, and the drive state of the various actuators 32, 42, and 52 used for deriving the movable range RT are states before the present states by the time required for communication. Consequently, the movable range deriving unit 13 can derive the movable range RT in view of the time required for communication.

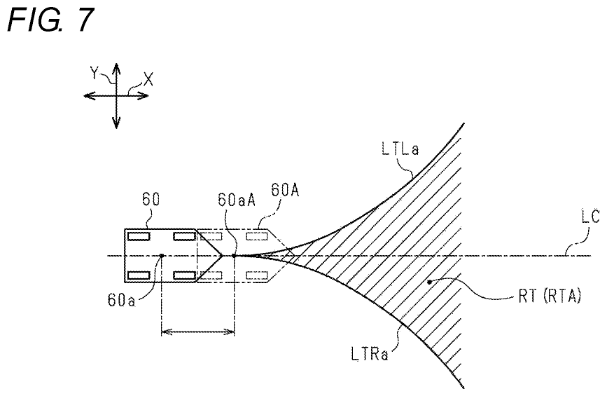

FIG. 7 illustrates an example of the movable range RT derived in view of the time required for communication. Time TM required for communication is known in advance. The position of the vehicle 60 at the time point when the time TM has elapsed is predicted, and the right limit line LTRa and the left limit line LTLa are derived by using the position as a reference. Note that a vehicle 60A indicated by a two-dot chain line in FIG. 7 corresponds to the predicted position of the vehicle 60 after the time TM elapses. In this manner, the region surrounded by the right limit line LTRa and the left limit line LTLa can be derived as the movable range RT in view of the time TM required for communication. By setting a point in the target path TTL included in the movable range RT as the target position PTr, it is possible to further enhance the effect of preventing the vehicle 60 from being requested to travel beyond the movable range of the vehicle 60.

In each embodiment, whether to select the unidirectional turning movable range RTA or the bidirectional turning movable range RTB as the movable range RT is determined by using the relational expressions (Formula 1) and (Formula 2). However, the selection can be performed using another method. For example, the selection can be performed on the basis of the shape of the target path TTL. In this case, the unidirectional turning movable range RTA can be selected as the movable range RT when the target path TTL is curved, and the bidirectional turning movable range RTB can be selected as the movable range RT when the target path TTL is not curved.

The index Z can be varied. For example, in a case where there is an obstacle around the vehicle 60, the index Z can be made smaller than a case where there is no obstacle. In addition, the index Z can be made smaller as the number of obstacles present around the vehicle 60 is larger. Furthermore, the index Z can be made smaller as the distance between the vehicle 60 and the obstacle is shorter. In this case, it is preferable that the smaller the index Z, the more easily the distance between the restricted right turning limit line LTRL and the restricted left turning limit line LTLL is increased as the vehicle 60 moves away from the current position in the longitudinal direction X.

When it is necessary to avoid a collision between an obstacle and the vehicle 60, the movable range RT can be derived without reflecting the index Z.

In each of the embodiments described above, among a plurality of points on the target path TTL included in the unidirectional turning movable range RTA, a point closest to the vehicle 60 in the longitudinal direction X is set as the temporary target position PTrA. However, a point other than the point closest to the vehicle 60 in the longitudinal direction X can be set as the temporary target position PTrA.

In each of the embodiments described above, at the time of deriving the target position PTr, a point closest to the vehicle 60 in the longitudinal direction X among a plurality of points on the target path TTL included in the movable range RT is set as the target position PTr. However, a point other than the point closest to the vehicle 60 in the longitudinal direction X can be set as the target position PTr.

The movable range deriving unit 13 can be provided in the driving control ECU, and the target setting unit 14 can be provided in the driving plan generation ECU. In this case, when the movable range RT is derived by the movable range deriving unit 13, the movable range RT is transmitted to the driving plan generation ECU. When the target setting unit 14 determines that the vehicle 60 deviates from the target path TTL, the target position PTr is set on the basis of the received movable range RT.

In each of the embodiments described above, the driving control ECU also has a function of controlling the braking actuator 32. However, the braking control unit 23 can be provided in an electronic control device different from the driving control ECU.

The target path generation unit 11, the movable range deriving unit 13, the target setting unit 14, the control amount deriving unit 21, and the instruction unit 22 can be provided in one electronic control device.

In each of the embodiments described above, the travel control device includes two electronic control devices, but the present disclosure is not limited thereto, and the travel control device may include three or more electronic control devices.

Next, technical ideas that can be grasped from the above embodiments and modifications will be described.

(A) It is preferable that the movable range deriving unit derives a maximum movable range on the basis of at least a traveling state of a vehicle among the traveling state of the vehicle and a state of a road surface on which the vehicle travels, derives a restricted movable range on the basis of an index related to ride comfort felt by an occupant of the vehicle, and sets a narrower one of the maximum movable range and the restricted movable range as the movable range.

(B) It is preferable that the instruction unit instructs the actuator to drive a vehicle so as not to change a turning direction of the vehicle when the unidirectional turning movable range is selected as the movable range, and instructs the actuator to drive the vehicle so as to turn in one of a right direction and a left direction of the vehicle and then to turn in another direction when the bidirectional turning movable range is selected as the movable range.

1. A travel control device for a vehicle that eliminates deviation of a vehicle from a target path by driving an actuator of the vehicle when the vehicle deviates from the target path, the travel control device for a vehicle comprising:
a movable range deriving unit that derives a movable range that is a range in which the vehicle is able to reach by driving the actuator on a basis of a traveling state of the vehicle;
a target setting unit that sets a point included in the movable range in the target path as a target position; and
an instruction unit that instructs the actuator to drive the vehicle toward the target position.

2. The travel control device for a vehicle according to claim 1, wherein the movable range deriving unit derives the movable range on a basis of a traveling state of the vehicle as a result of drive of the actuator, a state of a road surface on which the vehicle travels, and an index related to ride comfort felt by an occupant of the vehicle.

3. The travel control device for a vehicle according to claim 2, wherein
in a case where a target of an attitude angle of the vehicle when the vehicle reaches the target position is set as a target attitude angle,
the movable range deriving unit performs
a process of deriving a unidirectional turning movable range that is a movable range in a case where a turning direction of the vehicle is not changed,
a process of deriving a bidirectional turning movable range that is a movable range in a case where the vehicle is turned in one of a right direction and a left direction of the vehicle and then in another direction, and
a process of selecting one of the unidirectional turning movable range and the bidirectional turning movable range as the movable range on a basis of a current position of the vehicle, the temporary target position, and the target attitude angle, the temporary target position being set as a point in the target path included in the unidirectional turning movable range, and
the instruction unit instructs the actuator to drive the vehicle toward the target position and to set an attitude angle of the vehicle when the vehicle reaches the target position as the target attitude angle.

4. The travel control device for a vehicle according to claim 3, wherein
the travel control device includes a plurality of electronic control devices capable of transmitting and receiving information to and from each other, and
among the plurality of electronic control devices, a first electronic control device includes the target setting unit and the movable range deriving unit, and a second electronic control device includes the instruction unit, and
the movable range deriving unit derives the movable range in view of time required for transmission and reception of information between the second electronic control device and the first electronic control device.

5. The travel control device for a vehicle according to claim 2, wherein
the travel control device includes a plurality of electronic control devices capable of transmitting and receiving information to and from each other, and
among the plurality of electronic control devices, a first electronic control device includes the target setting unit and the movable range deriving unit, and a second electronic control device includes the instruction unit, and
the movable range deriving unit derives the movable range in view of time required for transmission and reception of information between the second electronic control device and the first electronic control device.

6. The travel control device for a vehicle according to claim 1, wherein
the travel control device includes a plurality of electronic control devices capable of transmitting and receiving information to and from each other, and
among the plurality of electronic control devices, a first electronic control device includes the target setting unit and the movable range deriving unit, and a second electronic control device includes the instruction unit, and
the movable range deriving unit derives the movable range in view of time required for transmission and reception of information between the second electronic control device and the first electronic control device.

7. The travel control device for a vehicle according to claim 1, wherein
in a case where a target of an attitude angle of the vehicle when the vehicle reaches the target position is set as a target attitude angle,
the movable range deriving unit performs
a process of deriving a unidirectional turning movable range that is a movable range in a case where a turning direction of the vehicle is not changed,
a process of deriving a bidirectional turning movable range that is a movable range in a case where the vehicle is turned in one of a right direction and a left direction of the vehicle and then in another direction, and
a process of selecting one of the unidirectional turning movable range and the bidirectional turning movable range as the movable range on a basis of a current position of the vehicle, the temporary target position, and the target attitude angle, the temporary target position being set as a point in the target path included in the unidirectional turning movable range, and
the instruction unit instructs the actuator to drive the vehicle toward the target position and to set an attitude angle of the vehicle when the vehicle reaches the target position as the target attitude angle.

8. The travel control device for a vehicle according to claim 7, wherein
the travel control device includes a plurality of electronic control devices capable of transmitting and receiving information to and from each other, and
among the plurality of electronic control devices, a first electronic control device includes the target setting unit and the movable range deriving unit, and a second electronic control device includes the instruction unit, and
the movable range deriving unit derives the movable range in view of time required for transmission and reception of information between the second electronic control device and the first electronic control device.
